(19) United States
(12) Patent Application Publication
(10) Pub. No.: US 2019/0024648 A1
(43) Pub. Date: Jan. 24, 2019

(54) ARCHITECTURE FOR A SYSTEM OF INTEGRATED PUMPS, MIXERS, AND GATES FOR MICROFLUIDIC DEVICES

(71) Applicant: Mir Abbas Jalali, Sunnyvale, CA (US)

(72) Inventor: Mir Abbas Jalali, Sunnyvale, CA (US)

(21) Appl. No.: 15/653,279

(22) Filed: Jul. 18, 2017

(51) Int. Cl. F04B 19/00; F04B 17/03; B01F 13/00; B01F 11/00

(52) U.S. Cl. CPC F04B 19/006; B01F 11/0071; B01F 13/0059; F04B 17/03

(57) ABSTRACT

A single, or a cascade of magnetically actuated blades are used to simultaneously pump and mix fluids in continuous-flow microfluidic devices. The external magnetic field, which traps the blade and controls its motion, is generated by a carpet of micron-scale coils. The frequencies and amplitudes of the blade's translational and rotational motions are controlled by voltage and current waves that pass through the carpet of the microcoils. When the frequency ratios of the translational and rotational motions of the blades do not commensurate, the pumped fluid is mixed chaotically. Chaotic mixing is also achieved when a single blade moves on a rosette-like quasi-periodic path. The invented micro pumping and mixing device negates connections to external pumps, and does not need specially-carved channels to mix flowing liquid. The microcoils are printed or installed on glass or polymeric substrates. The blades can also be used as controllable gates in microfluidic circuits. The blades are embedded and sealed in microchannels or pumping chambers; the device composed of the blades and microcoils is disposable.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to microfluidic devices, and more particularly to technology of electromagnetic mechanical devices for the pumping, mixing and segregation of fluids in a microfluidic devices.

### BACKGROUND

Microfluidic devices currently represent the hot technology for systems in which low volumes of fluids are processed to achieve multiplexing, automation, and high-throughput screening. In these devices, precise control and manipulation is necessary for fluids that are geometrically constrained to a small, typically sub-millimeter scale passage, generally on a microfluidic card of substrate. Micro-channel sizes of 100 nanometers to 500 micrometers is common.

The fluid in a micro-channel of a microfluidic structure requires constant circulation and mixing, necessitating a fluid flow. Flow in microfluidic devices is generated by two general classes of pumps: (i) external pumps and (ii) integrated pumps. Prominent external pumps are pressure, vacuum, and syringe pumps, which induce continuous flow rates with arbitrarily high pressure levels. Most Integrated pumps are non-mechanical, including electroosmotic and electrowetting pumps that have been devised for continuous-flow microfluidics and droplet handling devices. Flexible diaphragms actuated by pressure, vacuum or piezoelectric actuators, and peristaltic pumps are mechanical systems that can be used both as external and integrated pumps in low flow rate regimes. Peristaltic pumps are particularly useful for generating long-term flow in closed circuits, e.g., in biological reactors. Capillary pumps are another class of integrated pumps. They work based on the wetting characteristics of the fluid and substrate, and are categorized as non-mechanical pumps.

Mixing of the fluids in microfluidic devices is considered a different function from pumping. There are two general mixing mechanisms: passive and active. Passive mixers use specially-carved cascade of channels to stir the flow stream and mix it. Active mixers, often use pressure pulses, ultrasonic waves, and magnetic bead motion to perform mixing function.

The current trend in biology, diagnosis and point-of-care medicine is to handle minuscule amounts of fluid (e.g., blood sample) and remove connections to external pumps by integrating pumps and mixers to microfluidic chips. This demand has caused a bias towards adopting non-mechanical pumps, mostly those based on electrowetting and electroosmosis. However, the efficiency of electrowetting pumps depends on the fluid's surface tension properties and how the fluid responds to an electric potential field. Moreover, electroosmotic pumps are limited to conducting liquids and suffer from permittivity, zeta, and bubble formation problems.

The miniaturization of mixers in continuous-flow microfluidic devices is a technical challenge. A large pressure gradient is required to generate flow through the commonly used passive mixers with a cascade of curved geometries. Most integrated pumps are not powerful enough to provide the required pressure gradient.

Henceforth, a microfluidic chip that has integrated miniaturized pumps, valves and mixers that could combine the pumping and mixing functions in a circulatory flow in a single unit, would fulfill a long felt need in the fields of biology, diagnosis and point-of-care medicine where miniscule volumes of fluid are manipulated. This new invention utilizes and combines known and new technologies in a unique and novel configuration to overcome the aforementioned problems and accomplish this.

### BRIEF SUMMARY

In accordance with various embodiments, a microfluidic chip device with integrated pumping and mixing capabilities is provided.

In one aspect, a microfluidic chip with the capability of overcoming undesired sedimentation and separation of fluids introduced into its micro-channel by continual stirring and repeated twisting of parallel straight fluid streamlines is provided.

In another aspect, the structural architecture of a microfluidic chip with integrated pumping unit, mixing unit and or valving unit is provided.

In yet another aspect, a microfluidic device with at least one microchannel formed therein with at least one moveable blade positioned therein so as to be capable of translational and or rotational movement to facilitate fluid movement, direction or isolation in the microchannel.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a perspective view of a microfluidic device with two rotatable magnetic blades in its micro-channel;

FIGS. 2A-D are top views of the microfluidic device sequentially showing the reciprocating motion of its magnetic blades to pump fluid along its micro-channel;

FIGS. 3A-F are top views of a second embodiment microfluidic device sequentially showing pumping and mixing in its closed circuit;

FIGS. 4 A-C are perspective, top and side views of a typical preferred embodiment valve rotor unit:

FIG. 5 is a perspective view of an array of microcoils on a planar substrate housing;

FIG. 6 is an exploded view of an array of microcoils for installation in a planar substrate housing;

FIG. 7 is a perspective view of a multilayer microfluidic device;

FIGS. 8 A and B are perspective views of an array of microcoils sequentially showing rotating the rotor;

FIGS. 9 A-E are bottom views of a micro-channel, two rotors and their associated microcoils in a sequential pumping operation;

FIGS. 10 A-E are bottom views of a micro-channel, two rotors and their associated microcoils in a sequential spin phase;

FIG. 11 A is a top view of an alternate embodiment rotor unit showing the polarity of the central magnet;

FIGS. 11 B-D are perspective, front and top views of the blade;

FIG. 12A is a side view of the microfluidic substrate, rotor and attached blade unit, rotor housing, and blade access hole;

FIG. 12 B is a side view of the microfluidic substrate, rotor blade unit, rotor housing, and blade access hole for the blade where the blade and its hub are separate from the rotor;

FIG. 13 is a top view of a microfluidic channel showing blade actuation by longitudinal and lateral microcoils;

FIGS. 14 A-E are top views of a microfluidic channel sequentially showing microcoils rotating and translating a blade with a magnetic hub.

FIG. 15A is a top view of a microfluidic junction;

FIG. 15B is a top view of a rotor and its crescent-shaped blade used as a valve or gate for the microfluidic junction of FIG. 15A.

FIGS. 16 A-D are top views showing a rotor transposed atop a microfluidic junction and sequential images of its crescent-shaped blade altering fluid flow patterns;

FIG. 16 E is a top view of the array of microcoils used to move the rotor;

FIG. 16 F is a top view the array of microcoils placed atop the rotor;

FIG. 17A is a top view of a microfluidic device with a pumping unit and a rotary gate;

FIG. 17B is a top view of a microfluidic device showing the rotary gate in a closed configuration; and

FIG. 17C is a top view of a microfluidic device showing the rotary gate generating a wavy fluid interface;

### DETAILED DESCRIPTION OF CERTAIN EMBODIMENTS

While various aspects and features of certain embodiments have been summarized above, the following detailed description illustrates at least on exemplary embodiment in further detail to enable one skilled in the art to practice such an embodiment. The described example is provided for illustrative purposes and is not intended to limit the scope of the invention.

In the following description, for the purposes of explanation, numerous specific details are set forth in order to provide a thorough understanding of the described embodiment/s. It will be apparent to one skilled in the art, however, that other embodiments of the present invention may be practiced without some of these specific details. While various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As used herein the term “micro-channel” refers to a channel with a hydraulic diameter below 1 mm. Micro-channels are commonly used in fluid control and heat transfer.

As used herein the term “microfluidic chips or microfluidic structure” refers to at least one micro-channel etched or molded into a material (generally glass, silicon or polymers such as PolyDimethylSiloxane). The micro-channel/s forming the microfluidic chip are connected together in order to achieve the desired features (mix, pump, sort, control bio-chemical environment). To be deemed “microfluidic” least one dimension of the micro-channel must be in the range of a micrometer or tens of micrometers.

As used herein the term “microfluidic devices” refers to microfluidic chips or microfluidic structures that have integrated pumps, mixers and/or gates that can be used to move, mix and direct the fluid within the micro-channel/s. In microfluidic devices the network of micro-channels molded (formed or cut) into the microfluidic chip are connected to the outside by inputs and outputs pierced through the chip, as an interface between the macro- and micro-world through which the liquids (or gases) are introduced and removed from the microfluidic chip or structure.

As used herein the term “integrated” with respect to a microfluidic device means a system for pumping, mixing, directing and/or and isolating fluids within the microchannel/s of the microfluidic chip wherein the physical structure responsible for the pumping, mixing or directing and isolating fluids is physically contained on or in the microfluidic card. The power supply and microcoil controller may be physical connected with the pumping, mixing, directing and isolation means. The act of integration referrers to the blades, rotor and microcoils.

The present invention relates to a novel design for a microfluidic device, having several embodiments for pumping, mixing and segregating or directing fluids introduced into the micro-channel of the fluidic microchip.

Fluid flow in micro-channels is laminar, so that in average, particles move along straight lines. The only causes of deviation from straight trajectories are thermal fluctuations, shear-induced particle-particle collisions, and gravity. The first two effects are commonly known as diffusion. Thermal fluctuations lead to the so-called Brownian random walk of particles. The shear-induced migration, which occurs in most biological fluids, emulsions, and colloidal fluids, usually leads to the separation of particles of different sizes and demixing. Sedimentation is the most prominent result of gravity. In order to overcome undesired sedimentation and separation in applications such as diagnosis, bioreactors, sample dilution, rapid cystallisation, and nanoparticle synthesis, the fluid needs to be stirred continuously and parallel straight streamlines be twisted repeatedly. The proposed invention solves this problem using an integrated microfluidic system.

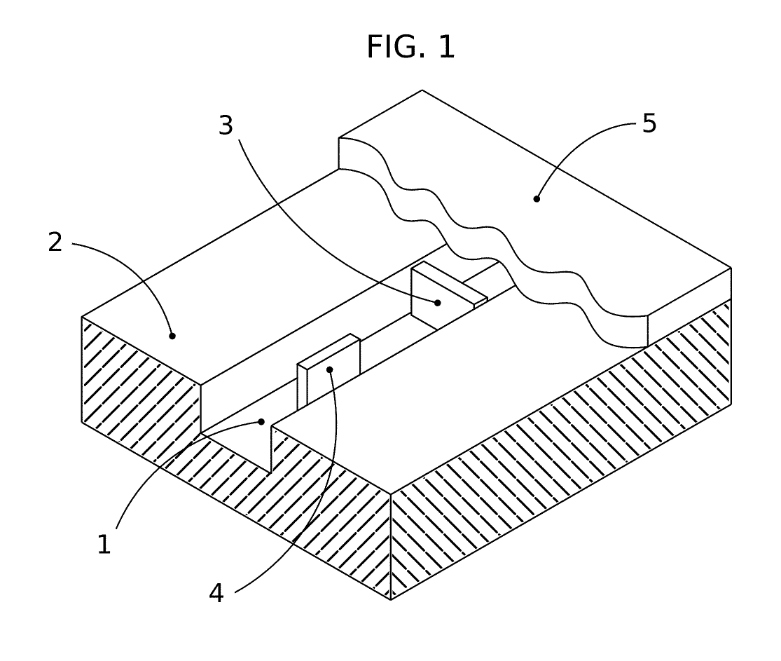

Looking at FIG. 1, a schematic view of a micro-channel 1 carved in a lower layer glass or a polymeric substrate 2 with moveable (translatable or rotatable) first and second magnetic blades 3 and 4 located in the micro-channel 1 can be seen. The blades are generally planar and are dimensionally sided for rotational and translational movement within the microchannel. There is an extremely close tolerance between the edges of the blades 3 and 5 and the walls of the microchannel.

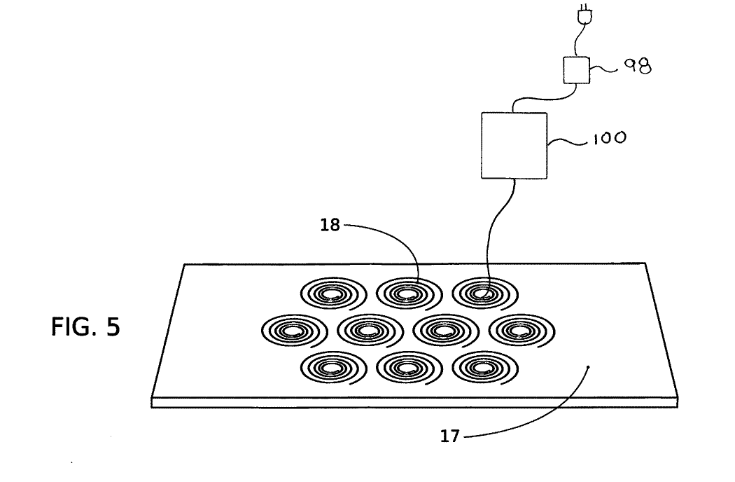

It has an array of microcoils 18 (FIG. 5), which are installed in the upper layer 5 adjacent the rotor and in close enough proximity to affect magnetic movement of the disk magnets that are housed in the rotor. The upper layer can be made of glass or polymeric materials. In the shown configuration, blades 3 and 4 move, respectively, broad side and edge-wise along the channel in a rectilinear fashion.

The pumping system of the preferred embodiment consists of a single, or a cascade of magnetized blades, which are driven in a typical micro-channel 1. The motion of each blade has translational (generally rectilinear) and rotational phases, or combinations thereof. First blade 3 and second blade 4 are anti-aligned in FIG. 1. The micro-channel 1 is carved as a trough or dado within a glass or polymeric substrate 2. An upper glass or polymeric layer 5 covers the substrate 2. Layer 5 contains the blade actuators.

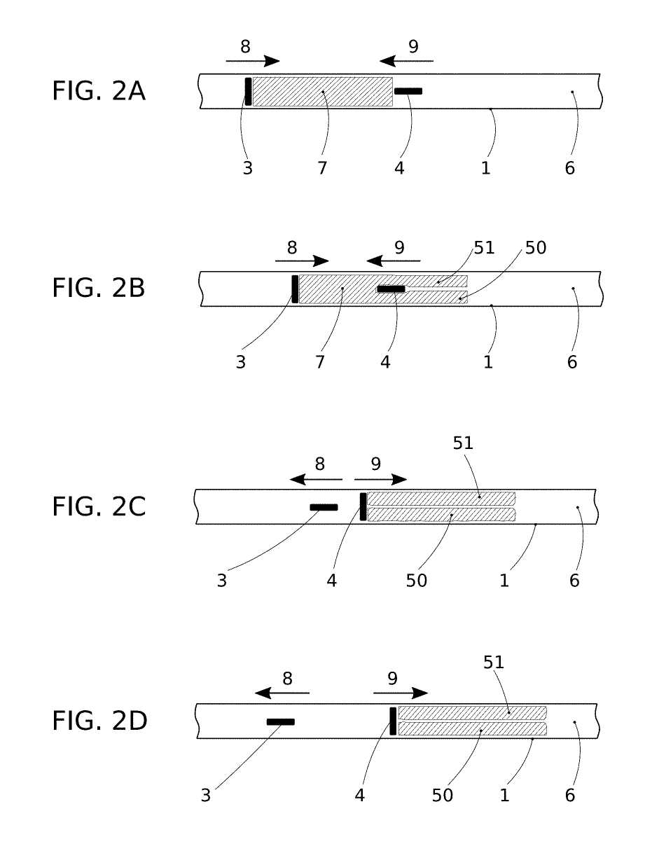

Looking at FIGS. 2A-D, a sequential series shown from a top view of the micro-channel shows the reciprocating motion of the blades, which is the mechanism of pumping. As shown in FIG. 2A, micro-channel 1 is filled with fluid 6. When blade 3 moves broad-side along the channel in the direction indicated by arrow 8, it pushes the fluid like a piston in the direction of arrow 8. At the same time, blade 4 moves edge-wise but in the opposite direction of the blade 3 as indicated by direction arrow 9. (FIG. 2B) The fluid slug 7 initially between the two blades is split by blade 4 as it is forced past it. The motion of blade 4 does not generate a reverse flow because the pumping force exerted by blade 3 overwhelms that of blade 4. Nonetheless, blade 4 divides the approaching fluid element to first part 50 and second part 51. (FIGS. 2B and 2C) The blades 3 and 4 then each rotate 90 degrees in the micro-channel from their initial configuration shown. (FIG. 2C) In this blade orientation, blade 3 aligns itself with the micro-channel centerline and blade 4 resides perpendicular to it. (Reversing their initial configurations.) The first and second fluid elements 50 and 51 are now pushed forward by blade 4 (FIG. 2D). In a closed circuit, the system of two blades repeatedly breaks apart fluid slugs 7 and pumps them as packets. The sizes of the packets are determined by the maximum and minimum distances between the blades.

For a single fluid slug 7 in the channel, split first and second fluid elements 50 and 51 recombine immediately after passing blade 4, as is expected in a laminar flow situation. If the fluid slug 7 that approaches the system of two blades is comprised of different fluid substances, such as a drop of water or blood in mineral oil, first and second fluid elements 50 and 51 can form into two separate droplets. The preferred embodiment microfluidic device can alleviate this. The breaking process of droplets depends on the surface tensions of fluids and the relative speeds of the blades. The larger the strike speed of the blade to an incident droplet, the higher the chance of droplet splitting. By controlling the distance between blades and their stroking speeds, droplets can be broken to arbitrarily small sizes. Flow generated by the system of two blades is continuous and has a constant flow rate except momentarily when the blades rotate, changing their course of motion from the configuration in FIG. 2A to that of FIG. 2D. Since the pumping algorithm does not use any valves and the microfluidic channel is sealed, no bubbles are formed. This ability to retard droplet formation and avoid bubble formation is an unexpected result of the preferred embodiment microfluidic device.

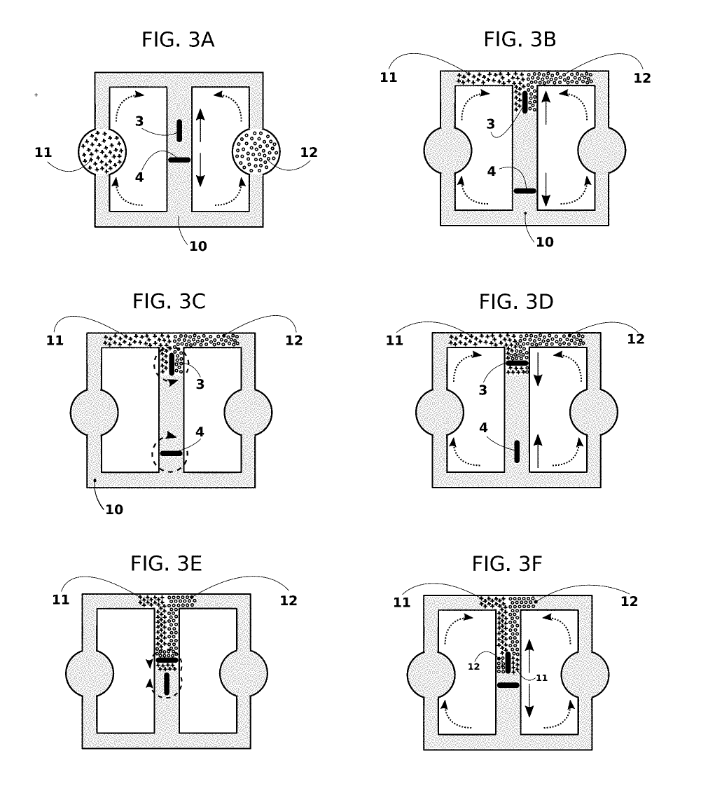

FIGS. 3A-F, top views of second embodiment microfluidic device, illustrate sequential fluid pumping and mixing in a closed circuit micro-channel. A background (carrier) fluid 10 fills the entire micro-channel except in the two chambers filled by first and second sample fluids 11 and 12. (FIG. 3A) First fluid sample 11 and second fluid sample 12 are pushed out of the two chambers they are introduced into, by the transverse movement of blades 3 and 4 away from each other (moving in the directions of solid arrows) (FIG. 3B) For the kinematic properties of the blades 3 and 4 shown, the fluid samples move upwards. When the two stream of fluid samples 11 and 12 reach the central channel, blade 3 has moved into the interface while blade 4 is still pumping. Blades 3 and 4 then rotate 90 degrees in the directions shown by the circular arrows. (FIG. 3C) Blade 3 displaces more of fluid 11 into the space between the two blades by virtue of its counter clockwise direction of rotation. (FIG. 3D) Now the blades 3 and 4 are translated towards each other (in a back-stroke configuration) and fluid samples 11 and 12 are further sucked into the central micro-channel and the fluid circulation continues in the direction of dotted arrows. After the blades 3 and 4 reach to their nearest distance, they rotate as shown by the circled arrows. (FIG. 3E) When blade 3 rotates, packets of the fluid samples 11 and 12 are transported to opposite sides of the channel. (FIG. 3F) In the next configuration, blades 3 and 4 increase the distance between them as they transverse apart along the central micro-channel thus pumping the fluid samples 11 and 12 out of the side containers of the central micro-channel and pulling them into the central micro-channel, while mixing the fluid samples 11 and 12. Blade 4 stretches and folds approaching fluid packets similar to the mixing accomplished by blade 3. Consequently, fluid elements gradually lose the information of their initial conditions through repeated migrations between the left and right hand sides of the central channel, and the two fluid samples 11 and 12 are mixed.

Mixing efficiency and speed depend on (i) the stroke length and relative velocity of the blades, and (ii) the angular velocities and phase angles of the blades. For example, if one introduces a delay to the rotation of blade 3 in FIG. 3E, the pumping motion of blade 4 in FIG. 3F will fuse the column of fluid 12 into the flipped packet of fluid 11, and vice versa. This enhances the mixing. If fluid samples 11 and 12 have significantly different surface tensions (or if they are immiscible), during entrance into the central channel, the fluid with higher surface tension will form droplets within the one with lower surface tension. In such a circumstance, blades 3 and 4 will break the droplets when they move edge-wise towards the droplets (e.g., FIGS. 2B, 2C and 2D). The alternate microfluidic device device in FIG. 3 can thus be used as an emulsifier where larger droplets are continuously broken to small ones in the circulatory flow. If necessary, more than two blades can be used in a microfluidic device for pumping, mixing and emulsification purposes. In long channels where the pressure drop is high, extra blades can be installed. They will function as flow boosters.

In this second embodiment microfluidic device, efficient mixing is achieved over several circulations. The closed circuit of the second embodiment can have a general structure, with arbitrary number of branches and junctions. The system can also be used as an emulsifier if fluids 10, 11, and 12 are immiscible.

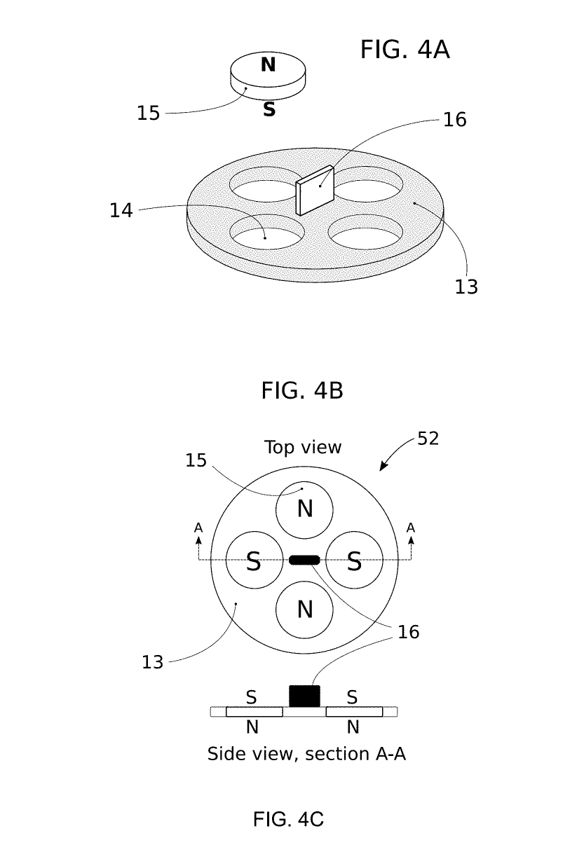

FIGS. 4 A, B and C illustrate perspective, top and side views of the preferred embodiment rotor 52 which serves as the motion control means for micro-scale blades. Micron-scale blades 3 and 4 are installed on proper rotors 52, which are actuated by an array of microcoils. The microcoils are adapted to change their magnetic polarity upon an input signal from a microcoil controller 100 which is powered by a power supply 98 and is well known in the field of electromagnetism. (FIG. 5 shows the controller 100 and power source 98 connected to only one microcoil for visual clarity.) As shown in FIG. 4A, a rotor 52 has a glass or polymeric substrate frame 12 on which a set of orifices 14 have been cut. Generally, this frame is of a planar, circular platter or disk configuration with a series of circular orifices cut therein sized for engagement with the disk magnets 15. A permanent disk magnet 15 is installed in each orifice 14. The magnetic pole lines of the disk magnets 15 can be aligned or anti-aligned depending on the control strategy adopted for rotating and moving the rotor 52. (FIG. 4B) The disk magnets 15 are magnetized along their symmetry axes. For a smooth operation, the thickness of the magnets should be equal to or less than the thickness of the rotor frame 12 as seen in the rotor side view. (FIG. 4C). The number of permanent disk magnets 15 and their placements in the rotor frame 13 is determined based on the arrangement and orientation of the microcoils, and the forces needed to simultaneously levitate and move the rotor 52. The rotor 52 can have an outer diameter between 0.5 and 5 millimeters, and its thickness can vary from 50 to 500 microns. The micron-scale blade 16 (FIG. 4A) is either implanted on the rotor frame, or is fabricated as an integrated part of the frame 13 using lithography techniques. The size of blade 16 is between 100 and 500 microns, and depends on the cross-sectional area of the micro-channel 1 it will be utilized in. The rotor 52 can be made from any material, including glass, polymers and metals.

FIG. 5 shows a perspective view of an array of spiral microcoils printed on a glass or polymeric substrate. There are two general methods to implement the array of microcoils 18. In the first method depicted in FIG. 5, a single or multiple layer of microcoil arrays are printed on glass or polymeric substrate 17 using photolithography and sputtering methods. Each microcoil 18 is connected to a microcoil control circuit as is well known in the industry, using appropriate printed wires. The control circuit is a electromagnetic device that is controlled by a microprocessor to enable the sequential magnetic polarity manipulation of each of the microcoils in the functional microcoil array as determined by an algorithmic set of instructions. Microcoils 18 can have circular or rectangular shapes, and be arranged in hexagonal or cubical patterns (FIG. 5 shows a hexagonal pattern). These patterns are determined by the translational movement path and location of rotational movement of the rotors with respect to the underlying microchannel. In the second method, microcoils are fabricated using magnet wires.

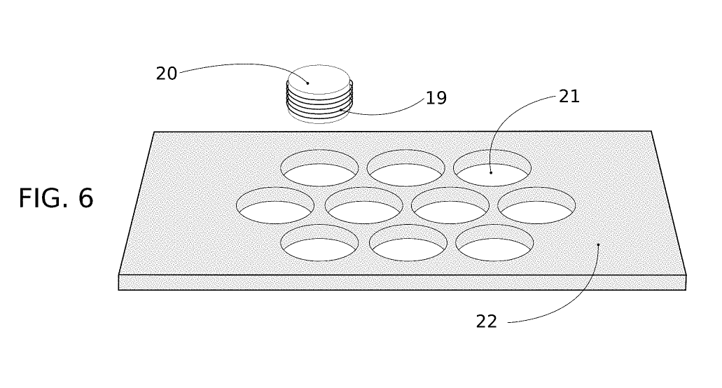

FIG. 6 is an exploded view of an array of wire microcoils 19 implemented in the second method, for installation in a planar substrate housing. As FIG. 6 shows, a wound wire microcoil 19 is wound around core 20, which can be ferromagnetic. Actuator units consisting of a wound microcoil 19 and their cores 20 are then installed in housings 21 cut on an extra glass or polymeric substrate 22. In both methods, the outer diameter of microcoils is between 200 and 1200 microns and the microcoils are placed above the rotor.

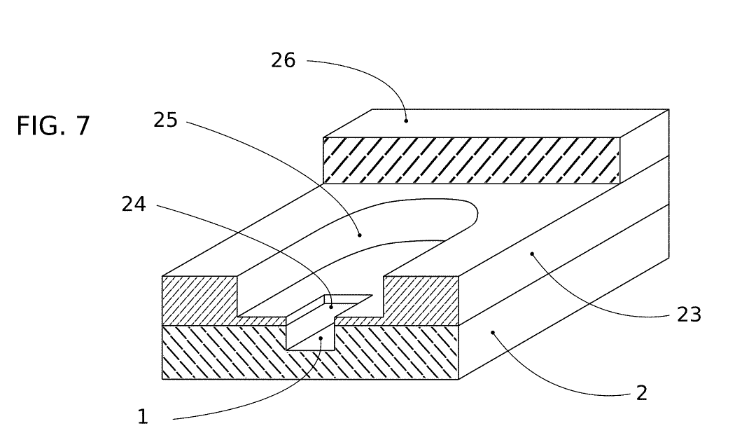

FIG. 7 is a perspective view of a multilayer microfluidic device composed of micro-channel 1 formed in a bottom layer, a central layer with a rotor chamber 25 formed therein to contain the rotor 52, a blade access orifice 24 formed below said rotor chamber 25 for the generally planar micron-scale blade 16 to extend from the bottom planar face of the rotor into micro-channel 1, and cover layer 26 to fluidically seal the microchannel 1 and on which the microcoils 18 are printed (FIG. 5) or the wound microcoil 19 is installed (FIG. 6).

The rotor 52 moves in chamber 25, which is carved in middle layer 23 Chamber 25 is connected to micro-channel 1 through blade access orifice 24. The micron-scale blade 16 passes through blade access orifice 24, (as they are in open communication) and reciprocates (in a linear fashion) and rotates in micro-channel 1. The layer 26 contains the array of microcoils, such as the hexagonal arrays of FIGS. 5 and 6, and covers middle layer 23. Cover layer 26, on which the microcoils are printed or installed, is fabricated separately and welded either by laser or special-purpose glues to the glass/polymeric piece 23. The blade has an extremely close tolerance fit between its edges and the walls of the microchannel 1. When the blade resides with its planar face perpendicular to the linear axis of the microchannel it is essential fluid tight, meaning that fluid can not freely pass between the walls of the microchannel and the edges of the blade.

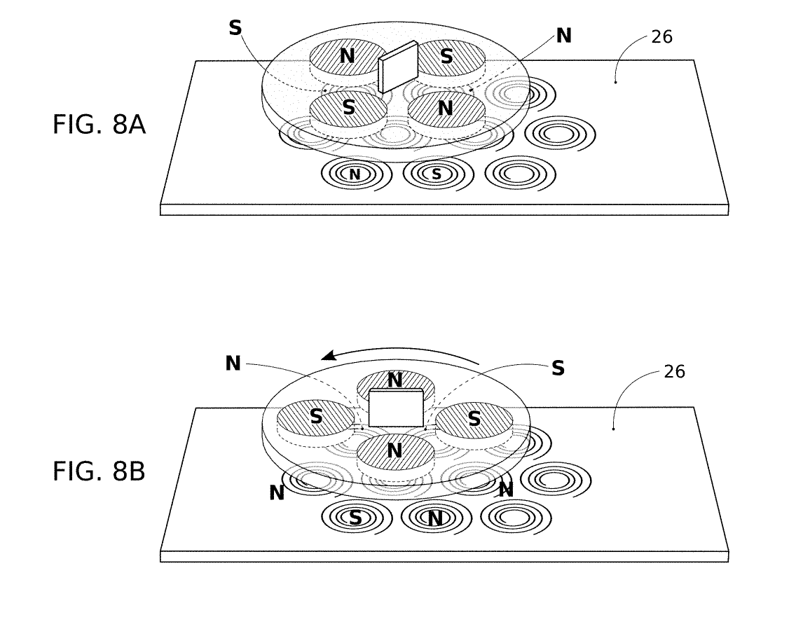

Looking at FIGS. 8A and B one can see the motion control (translation and rotation) accomplished by the rotor 52 and an array of printed microcoils 18. Basically, the moving and rotation of the rotor is accomplished by an array of microcoils. FIG. 8A illustrates stable repulsion of the rotor 52 and FIG. 8B illustrates simultaneous repulsion and rotation of the rotor 52. The rotor's position, orientation, and linear and angular speeds are controlled by the microcoils.

FIG. 8A shows a configuration where the rotor 52 is repelled by the microcoils 18 in the direction perpendicular to the plane of the coils. By reversing the polarities of the microcoils, the rotor is pulled towards the microcoil array. FIG. 8B shows a configuration at which the rotor is repelled and rotated by six active microcoils. The induced (instantaneous) rotation is in the direction of the arrow. A combination of repulsion and translational motion is also possible. By controlling the activation sequence of microcoils, the rotor 52 can undergo a hybrid translational and rotational motion while it maintains minimal contact with the substrate, reducing the frictional force.

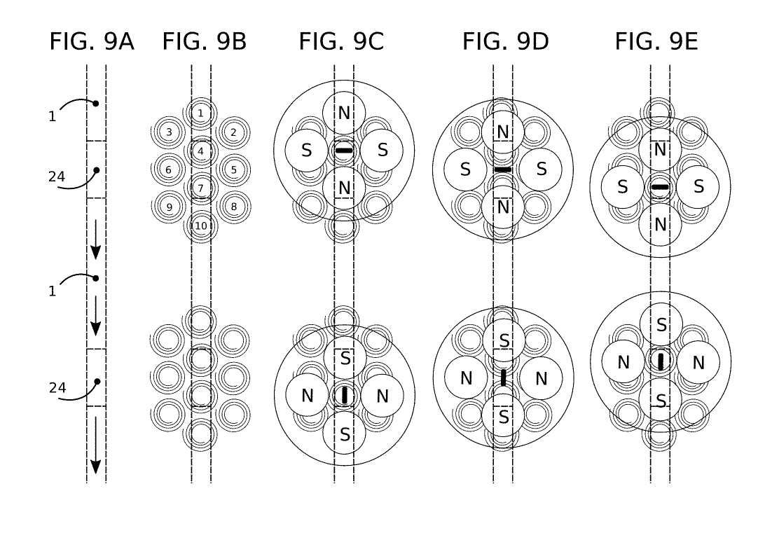

FIGS. 9A-E are bottom views of a micro-channel, two rotors and their associated microcoils in a sequential translational linear pumping operation. FIGS. 9C-E shows the translational motion of two rotors (each containing a blade) for pumping along the central channel and in the direction of the arrows (FIG. 9A). (This would be the pumping action seen in FIGS. 2A and B, Numbering the coils as in FIG. 9B, the rotors are actuated based on the following algorithm: In the first step (FIG. 9C), the current passing through coils 1 and 7 magnetizes them so that their faces next to rotor R1 become pole S. Consequently, rotor R1 is repelled away from the array. By switching the polarities of coils 2 and 3 to N, and those of coils 5 and 6 to S, the rotor moves and reaches the state of FIG. 9D. The distance that the rotor moves is half-way between coils 1 and 4. In the second step, the polarities of coils 5 and 6 become N to repel the rotor. By switching the polarities of coils 1 and 7 to S, and those of coils 4 and 10 to N, the rotor moves another step and reaches to the state of FIG. 9E. The blade of rotor R1 is perpendicular to the channel wall, and therefore, exerts maximum pressure force on the fluid inside the channel. Rotor R2 is controlled by a similar algorithm while its blade remains parallel to the channel. Once rotors R1 and R2 reach the state of FIG. 9E, they rotate so that the blades of R1 and R2 become parallel and perpendicular to the channel centerline, respectively in readiness for the pumping action seen in FIGS. 2C and D.

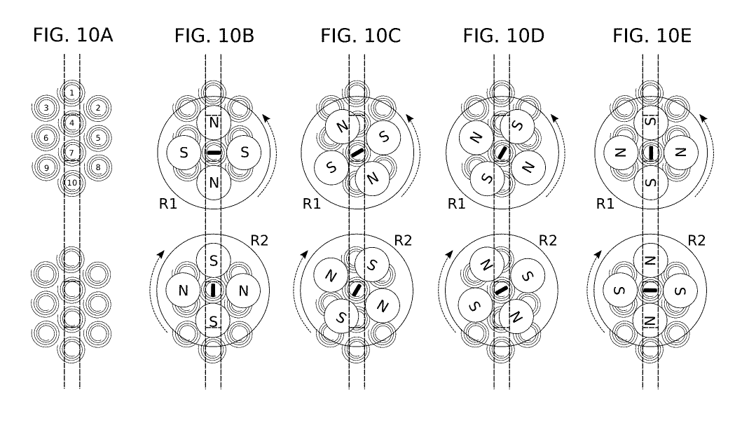

FIGS. 10A-E are bottom views of a micro-channel, two rotors and their associated microcoils in a sequential rotational linear pumping operation as can be seen in FIGS. 2C and D. FIGS. 10 A-E are bottom views of a micro-channel, two rotors and their associated microcoils in a sequential blade rotation movement. Rotors R2 and R1 spin clockwise and counter-clockwise, respectively. To spin rotor R1, coils 4 and 10 are switched on so that their magnetic poles towards the rotor disks become S and repel the rotor (FIG. 10B). By switching the magnetic poles of coils 6 and 8 to N, and those of coils 5 and 9 to S, rotor R1 spins by 30 degrees reaching to the state of FIG. 10C. The rotation from the state in FIG. 10C to 10D is performed by repeating the functions of coils 4, 10, 6, 8, 5, and 9 for coils 5, 9, 4, 10, 6, and 8, respectively, but with opposite polarities. For instance, the polarities of coils 5 and 9 are set to N, and those of 4 and 10 to S. The step from FIG. 10D to FIG. 10E, until the blade becomes parallel to the channel wall, is performed as the magnetic polarities of coils 6 and 8 become S, coils 5 and 9 become N, and coils 4 and 10 become S. Rotor R2 is rotated using a similar algorithm. Once the rotors take the orientations of FIG. 10E, the second pumping phase begins as the rotors distance from each other following the reverse algorithm of FIG. 9. The programing of the polarity controller for the microcoils is well known in the industry in this field of art and is not part of this invention, although the algorithm for the specific manipulations of the rotors 52 and microblades 3 and 4 will be specific to each type of microfluidic card.

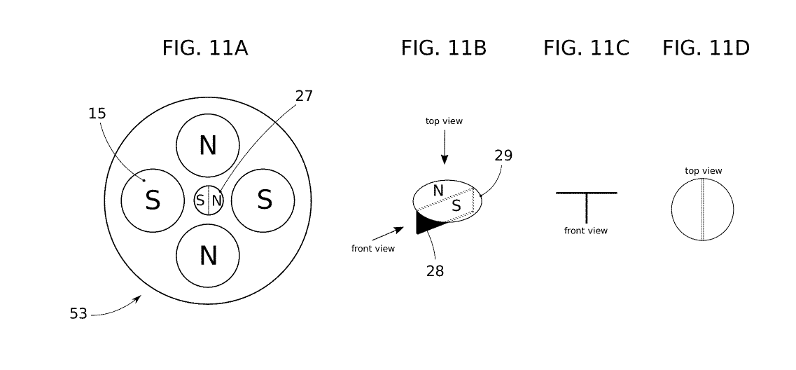

11A-D illustrate an alternate embodiment rotor wherein there are separate rotor and blade units to move and spin the blades. The alternative method to move and spin each blade is to (i) separate the rotor from the blade, (ii) isolate chamber 25 (in which the rotor moves/spins) from the microfluidic channel 1 by closing the access hole 24, (iii) magnetizing the blade and translate/rotate it without contact by the alternate embodiment rotor 53 by using a fifth small magnet installed at the center of the alternate embodiment rotor 53 (FIG. 11).

The alternate embodiment rotor 53 consists of a small magnet 27 centrally located on a rotor frame and four surrounding peripheral disk magnets 15. (FIG. 11A) The number of peripheral magnets 15 can vary based on the actuation algorithm of the alternate embodiment rotor 53. To prevent the rotational instability of removeable blade 28 and confine its rotational motion to a single degree of freedom, we attach a magnetic circular hub 29 to the removeable blade 28 (FIG. 11B). The size of central magnet 27 installed in the alternate embodiment rotor 53 matches the size of the blade's magnetic hub 29.

The pulling force by the rotor's central magnet 27 puts the circular hub 29 of the blade in contact with the micro-channel wall. In applications with short time scales and when the frictional force at contact surfaces is low, the direct contact between the hub 29 and micro-channel walls is negligible. Otherwise, the blade 28 and its hub 29 are neutrally floated in the channel. This is achieved by using a thin layer of Pyrolytic carbon at the top surface of the micro-channel. The size of the central magnet 27 matches that of the blade's hub 29.

The reason for having a rotor unit is due to the relatively large sizes of microcoils as compared to the size of the blade and its hub: blades typically have dimensions of 100 to 500 microns, and microcoils used for motion control (by microstepping techniques) have a minimum size of 500 microns. With more compact magnetic field generators, the rotor unit can be eliminated.

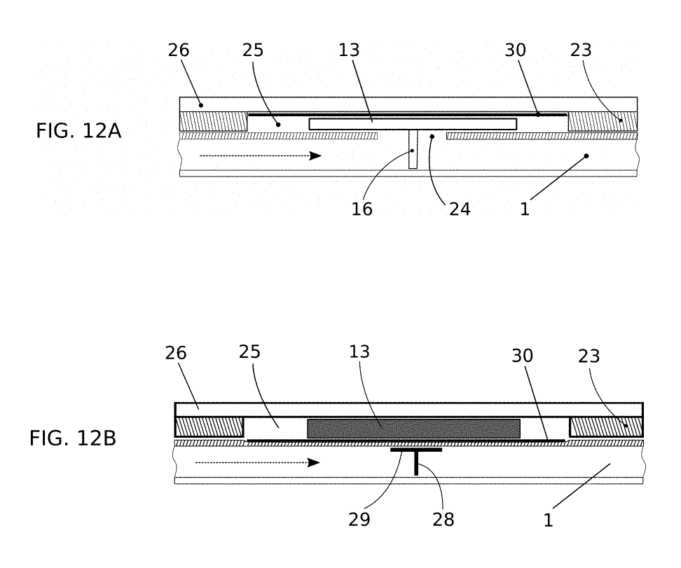

FIG. 12A demonstrates a side view of the installations of an integrated preferred embodiment rotor 52 and blade unit. The arrangement of the micro-channel, rotor and blade units, rotor's housing, and blade access hole for the blade can be seen. The blade moves broad side along micro-channel 1. (A) The blade is attached to the rotor. The microcoils have not been shown for visual clarity. The microcoils 18 or 19 are arranged in a hexagonal pattern on the upper plate 26 (similar to that shown in FIG. 6 or 8A and B).

FIG. 12B demonstrates a side view of the installations of the alternate embodiment design with separated rotor and blade units where there is no physical contact between the blade and the rotor. Here the blade and its hub are separate from the rotor, and micro-channel 1 is sealed from the rotor's housing 25, The microcoils have not been shown for visual clarity. The microcoils 18 or 19 are arranged in a hexagonal pattern on the upper plate 26 (similar to that shown in FIG. 6 or 8A and B).

In both designs the pumping chamber 25 is sealed. A Pyrolytic carbon layer 30 (or other low friction coating) may be used in both designs depending on operating conditions. The Pyrolytic carbon layer is not necessary in the design of FIG. 12A where the levitation of rotor 12 is controlled by microcoils. In this design, blade 16 is joined to rotor 12.

In the design of FIG. 12B, rotor 12 plays the role of a magnetic coupling between microcoils and the blade's hub 29. Due to the stretching and bending of magnetic field lines, rotor 12 adds flexibility to the dynamics of the moving parts. The introduction of phase leads and lags to the actuation algorithm of the microcoils allows the pumping function of the microfluidic device to be precisely controlled.

In the design of FIG. 12A, the rotor's chamber is initially charged with one of the fluid components that is supposed to flow through micro-channel 1. This is done to prevent possible air bubble leakage from the rotor's chamber into the main microfluidic channel. The elasticity and viscosity of the trapped fluid (in the design of FIG. 12A) or air (in the design of FIG. 12B) in the rotor's chamber are modeled in the governing equations of motion and then implemented in control algorithms. The size of the rotor's chamber is designed so that the fluid/air inside the chamber is displaced easily without causing a considerable reduction in the actuation force required for pumping. In the design of FIG. 12A, the clearance between the rotor's lower circular face and the upper side of the channel (at the access hole 24) is smaller than the width/height of the channel. Therefore, the fluid in the micro-channel 1 feels more resistance to flow into the rotor's chamber than flowing through the channel.

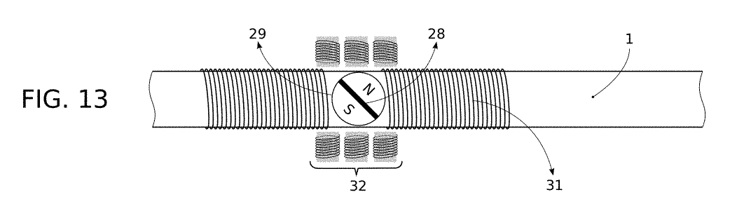

FIG. 13 is a top view of a microfluidic channel illustrating an alternate embodiment arrangement of the microcoils 19 around micro-channel 1. Here it can be seen the blade motion actuation may be accomplished using longitudinal and lateral microcoils. The blade and its hub have the physical attributes and the geometry of FIG. 11B. The microchannel is sealed from fluid leakage through the use of a sealing layer and a separate rotor and blade design. Microcoils can also be installed in three dimensional configurations. Two sets of longitudinal and lateral microcoils are used: the longitudinal set 31 is wound around the channel so that the symmetry axes of the coils are aligned with the channel centerline. The lateral set 32 is installed so that the symmetry axes of the microcoils are perpendicular to the channel centerline. The longitudinal set (consisting of two coils, which generate a strong magnetic field) is responsible for the pumping action and moving the broad side of blade 28 along the channel. The lateral set controls the edge-wise returning motion of the blade and the blade's spin. The minimum number of lateral microcoils required to get both the spin and translational motions is four. To further stabilize the motion of the blade, two hubs 29 (upper and lower) can be used, leading to an H-shaped front view (compared to the T-shaped front view in FIG. 11B).

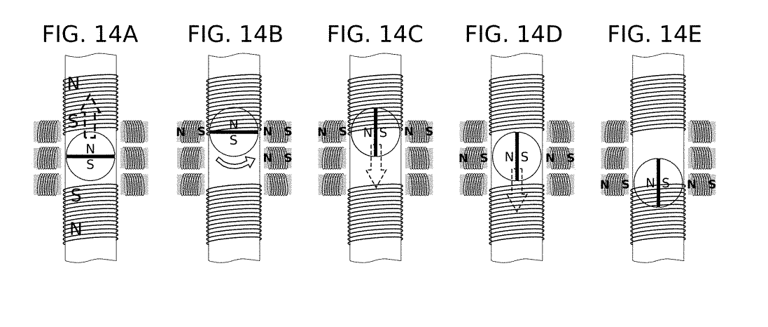

FIGS. 14 A-E are top views of a microfluidic channel sequentially showing microcoils rotating and translating a blade with a magnetic hub. The blade and its hub have the geometry of FIG. 11B. Algorithms applied to the microcoil controller are used to electronically sequentially actuate the microcoils so as effect the translational and rotational movement of the blade within a micro-channel. A sequence of such actuations are summarized in the five illustrations of FIG. 14. Straight and curved arrows show the direction of motion/rotation. By turning on the longitudinal coils, the magnetic hubs of the blade are aligned with the induced magnetic field (FIG. 14A) and the blade moves along the channel as its broad side pumps the fluid. The force and velocity of the blade may be regulated by using one or both of the longitudinal coils such that the blade may be pulled, pushed or pulled and pushed simultaneously. The force exerted on the fluid increases if two coils are acting in tandem such that one coil repels the blade and the other attracts it.

While the longitudinal coils are moving the blade along the channel centerline, the lateral coils may also be activated to suppress any flapping (small-amplitude rotational oscillations). In the returning motion, the longitudinal coils are turned off, and the lateral coils are activated according to the sequence of FIGS. 14B to 14E. The blade first makes a 90 degrees turn (FIG. 14B), then moves at three successive stages. Activating the middle-right coil in FIG. 14B breaks the symmetry and guarantees that the blade will rotate counter-clockwise. In the returning phase, the blade's rotational motion is stable because drag forces help the blade to align itself with the channel. The thinner the blade and its hub(s), the weaker the backward flow generated during the returning motion. In a system with two blades (FIG. 1) the backward flow is never observed because it is overwhelmed by the forward flow that the second blade induces. The distance that the blade travels depends on the number of lateral coils.

Inclined (oblique) movement of the blade can also be generated by the six microcoils of FIG. 14. In systems where wrapping the longitudinal microcoils (around the channel) is infeasible, the lateral microcoils can be used to generate the broad side motion of the blade. In summary, the blade's two degrees of freedom (translation along the channel and rotation about the symmetry axis of its hub) are controlled by electrical current waves passing through the array of microcoils. The relative sizes of microcoils with respect to the blade's hub determines the smoothness of motion and the pumping performance. The smaller the radii of microcoils, the smoother the motion/rotation of the blade.

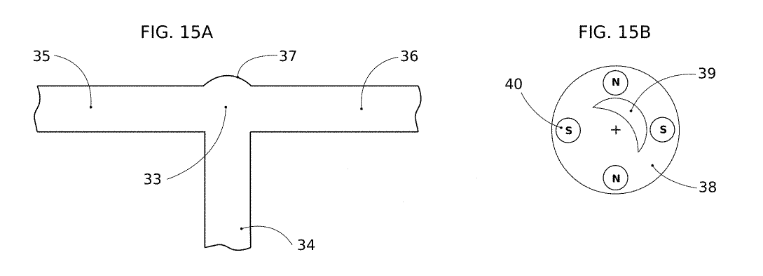

Spinning rotors with disk magnets and modified blade shapes can be used as electromagnetic valves and gates in microfluidic devices. FIG. 15A is a top view of a microfluidic junction and FIG. 15B is a top view of a rotor and its crescent-shaped blade used as a valve or gate in this microfluidic junction.

FIG. 15A shows circular junction 33 formed in the microfluidic card that connects micro-channels 34, 35, and 36 to each other at their intersection. Rotor 38 in FIG. 15B is similar to the rotor in FIG. 4, but its blade 39 is crescent-shaped. The center of the rotor's frame 38 has been marked by a cross “+”. Permanent disk magnets 40 have been installed in the rotor. The number of these magnets depends on the actuation algorithm and the number of microcoils required for spinning the rotor. Application of a blade and hub unit similar to FIG. 11B is also possible, but this time with a crescent-shaped blade.

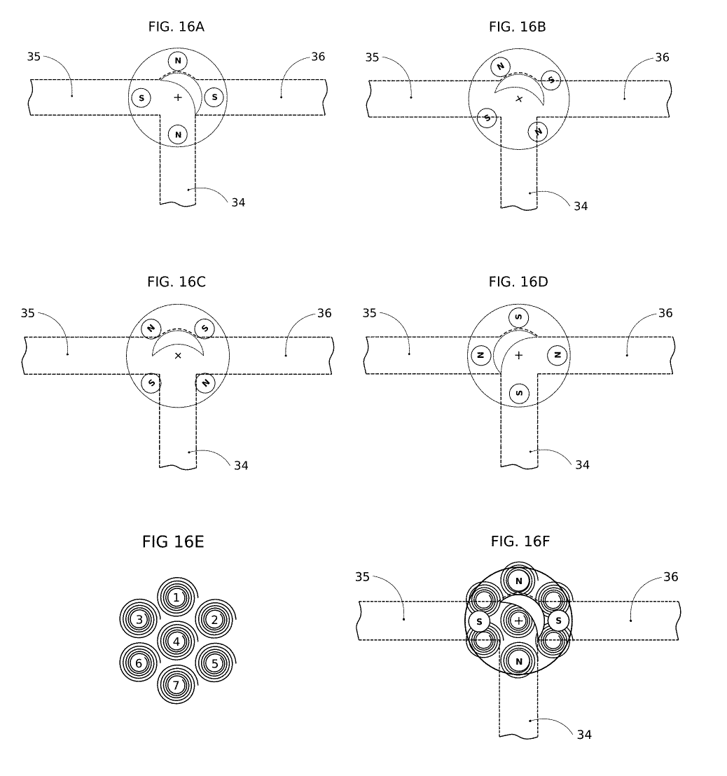

The rotor of FIG. 15B is installed in the microfluidic device so that the crescent-shaped blade 39 can rotate inside junction 33. The curved wall 37 has been designed to allow the blade to rotate without opening a large gap between the blade and the wall that connects branches 35 and 36. FIG. 16A shows a configuration at which the blade closes access to branch 36, connecting micro-channels 34 and 35.

FIGS. 16A-D show a rotor and its crescent-shaped blade as a valve or gate in microfluidic devices. The rotor, consisting of disk magnets, or having a magnetic hub similar to FIG. 11B, is actuated by an array of microcoils installed above the rotor and arranged at the junction as shown in FIGS. 16E-F.

Using a hexagonal array of microcoils (FIG. 16E) and with the microcoil controller applying the same control algorithm of FIG. 10 to the microcoils, rotor 38 is rotated counter-clockwise in FIG. 16B, and the crescent-shaped blade partially opens the gate for branch 36. Further rotation of the rotor in FIG. 16C, gives equal access from branch 34 to branches 36 and 37. The access to branch 35 is closed and micro-channels 34 and 36 are connected as the rotor and the blade reach to the configuration of FIG. 16D. The placement of the hexagonal array of microcoils, which actuate the rotor in FIGS. 16A, 16B, 16C, and 16D, has been shown in FIG. 16F. The number of microcoils and their arrangement may vary from one application to another. For instance, coil 4 may be removed when the pure rotation of the rotor is sought. Different shapes of blades, rather than a crescent-shaped blade, can also be designed depending on the junction geometry and the specific function of the gate.

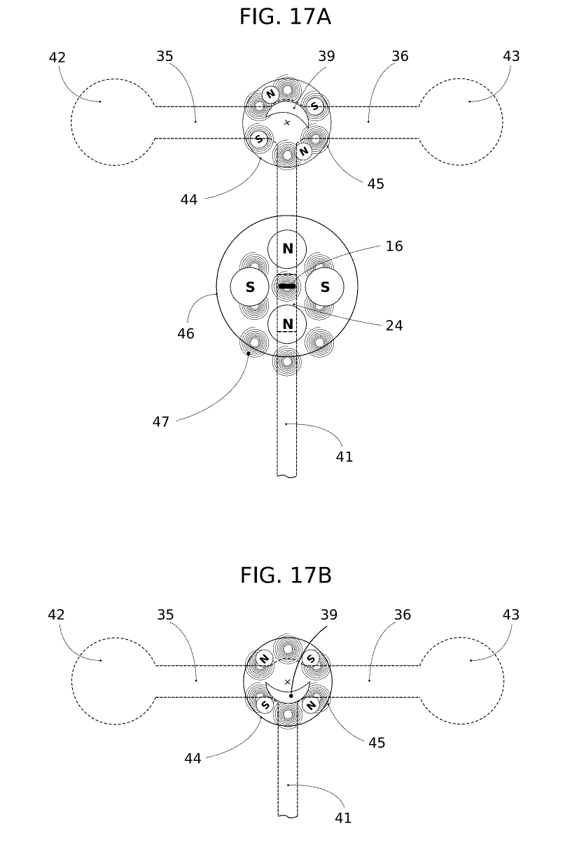

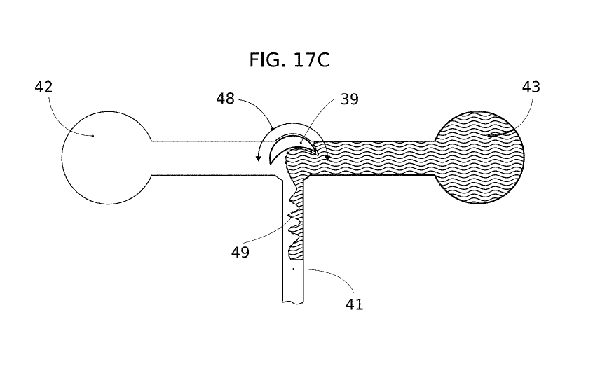

FIG. 17A is a top view of a microfluidic device with a combination of a pumping unit, composed of blade 16 and its rotor 46, and a rotary gate, composed of crescent-shaped blade 39 and its rotor 43, to mix fluid samples that initially fill chambers 42 and 43. Central channel 41 and the branches connected to chambers 42 and 43 are initially filled with a carrier/buffer fluid. Rotors 44 and 46 are actuated by microcoil arrays 45 and 47, respectively. The system can be used for droplet generation if fluids in chambers 42 and 3 are immiscible. (B) Gate configuration to close the central channel 41. (C) Generation of wavy interface by periodic rotation of gate 39 while rotor 46 is pumping the mixture along central channel 41.

By combining a pumping blade and a crescent-shaped gate (as in FIG. 16) a mixing device can be made (FIG. 17A). Rotor 46 is actuated by microcoil array 47, and its blade 16 can pump fluid along micro-channel 41 when it moves away from the junction. Consequently, fluid samples in chambers 42 and 43 are pulled towards gate 39. The crescent-shaped gate is fixed to rotor 44 and is actuated by microcoil array 45. The gate is capable of fully closing the passage to micro-channel 41 (FIG. 17B), and fully closing either of branches 35 or 36 connected to chambers 42 and 43, respectively (see FIGS. 16A and D). When the gate is more open on the side of chamber 42 (as FIG. 17A shows), and blade 16 is pumping, more fluid is pulled from chamber 42 into central channel 41. While pumping continues, if the gate rotates, it is possible to allow more fluid of chamber 43 into central channel 41. By sinusoidal or other periodic rotation of gate 39 (as shown by arrows 48), contact line 49 between the two fluid samples, within central channel 41, becomes wavy (FIG. 17C). Since the velocity profile in a micro-channel is parabolic (laminar Poiseuille flow), the wavy interface is later stretched along central channel 41. The folded (wavy) and stretched interface increases the contact surface of two fluid samples and triggers a mixing process. During the returning motion of the blade (when it moves edge-wise towards the junction), the crescent-shaped gate can fully close central channel 41 (FIG. 17B) to prevent back flow towards chambers 42 and 43.

Although the following embodiments are discussed in microfluidic dimensions (I.E. at least one dimension of the channel in the range of a micrometer or tens of micrometers) it is known that the invention may be utilized for the construction of integrated pumps, mixers, and gates for microfluidic devices in sizes outside of those deemed “microfluidic”.

While certain features and aspects have been described with respect to exemplary embodiments, one skilled in the art will recognize that numerous modifications are possible. For example, the sequential operation of the microcoils to translate and rotate the rotor and blades described herein may be implemented using microcoil controllers with hardware components, software components, and/or any combination thereof as is well known in the industry. Further, while various methods and processes described herein may be described with respect to particular structural and/or functional components for ease of description, methods provided by various embodiments are not limited to any particular structural and/or functional architecture, but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

Having thus described the invention, what is claimed as new and desired to be secured by Letters Patent is as follows:

1. A microfluidic device comprising:
a microfluidic chip containing at least one microchannel;
at least one rotor housed thereon or therein said microfluidic chip for rotational or translational motion;
at least one blade operatively connected to said rotor, said blade extending into said microchannel;
at least one permanent disk magnet mounted in said rotor; and
a microcoil array of at least one microcoil housed thereon or therein said microfluidic device, said microcoil capable of having its magnetic polarity changed between north, south or neutral,
wherein said microcoil is adjacent said disk magnet and in close enough physical proximity to said disk magnet to exert a magnetic force to urge the transverse or circular movement of said rotor therein.

2. The microfluidic device of claim 1 further comprising:
a multiple layer said microfluidic chip having a multilayer structure of a polymeric or glass substrate with a lower layer having said microchannel formed therein, a central layer having rotor chamber formed therein and a blade access orifice formed beneath said rotor chamber, and a cover layer affixed atop of said central layer so as to render said microchannel fluid tight; and
wherein said blade access orifice is in open communication with said microchannel;
wherein said blade extends normally from a bottom planar face of said rotor into said microchannel through said blade access orifice for engagement between the walls of the microchannel.

3. The microfluidic device of claim 1 wherein said rotor is a disk having a series of circular holes formed therein said rotor that are sized for the retention of said magnetic disks therein.

4. The microfluidic device of claim 3 further comprising:
a series of microcoils affixed with said cover layer, said microcoil adapted to change its magnetic polarity based on an input signal received from a microcoil controller, said series of microcoils arranged in a functional array to move and rotate pumping blade.

5. The microfluidic device of claim 4 wherein said microcoils are printed on the cover layer of the multilayer microfluidic chip above said rotor that moves and rotates the blade.

6. The microfluidic device of claim 4 wherein said microcoils are configured as a wound magnet wire microcoils around a ferromagnetic core; said wound magnet wire microcoils are housed in a series of conforming cutouts in an extra layer of substrate and placed atop said cover layer of said multilayer microfluidic chip, above said rotor.

7. The microfluidic device of claim 4 further comprising;
at least two microchannels in said microfluidic chip;
a circular junction formed in said microfluidic chip at an intersection of said at least two microchannels; and
wherein a crescent shaped gate is located and is rotatable in said junction, said crescent shaped gate sized to seal off at least one microchannel at a given time by rotating without opening a large gap between said gate and said microchannel wall.

8. The microfluidic device of claim 5 further comprising:
a magnetic circular hub from which said blade extends normally therefrom;
a rotor with a central permanent magnet approximating the size of said magnetic circular hub;
wherein said rotor and said blade are magnetically coupled and not in physical contact.

9. The microfluidic device of claim 6 further comprising:
a magnetic circular hub from which said blade extends normally therefrom;
a rotor with central permanent magnet approximating the size of said magnetic circular hub;
wherein said rotor and said blade are magnetically coupled and not in physical contact.

10. The microfluidic device of claim 8 further comprising:
a multiple layer said microfluidic chip having a multilayer structure of a polymeric or glass substrate with a lower layer having said microchannel formed therein, a sealing layer affixed to said lower layer sealing said microchannel fluid-tight, central layer having rotor chamber formed therein and a cover layer affixed atop of said central layer so as to constrain said rotor.

11. The microfluidic device of claim 9 further comprising:
a multiple layer said microfluidic chip having a multilayer structure of a polymeric or glass substrate with a lower layer having said microchannel formed therein, a sealing layer affixed to said lower layer sealing said microchannel fluid-tight, a central layer having rotor chamber formed therein and a cover layer affixed atop of said central layer so as to constrain said rotor.

12. The microfluidic device of claim 4 wherein the number of permanent magnet disks in said rotor is four and the number of microcoils is ten arranged in a hexagonal array.

13. A microfluidic device comprising:
a microfluidic chip containing at least one microchannel;
two longitudinal microcoils wound about said microchannel, said longitudinal microcoils having a first symmetry axis such that said first symmetry axis and a longitudinal centerline of said microchannel are common;
at least two lateral microcoils each having a second symmetry axis that resides perpendicular to said longitudinal centerline of said microchannel;
at least one permanent disk magnet;
a rotor housed therein said microfluidic chip for rotational or translational motion, said rotor is a disk having a series of circular holes formed therein said rotor that are sized for the retention of said magnetic disks therein;
wherein said microcoils are adjacent said rotor and in close enough physical proximity to said disk magnet to exert a magnetic force to urge the transverse or circular movement of said rotor therein when a magnetic polarity of said microcoils is changed between north, south or neutral upon an input signal; and
at least one blade operatively connected to said rotor, said blade extending into said microchannel.

14. The microfluidic device of claim 13 further comprising:
a multiple layer said microfluidic chip having a multilayer structure of a polymeric or glass substrate with a lower layer having said microchannel formed therein, a sealing layer affixed to said lower layer sealing said microchannel fluid-tight, a central layer having rotor chamber formed therein, and a cover layer affixed atop of said central layer so as to constrain said rotor.

15. The microfluidic device of claim 14 further comprising a magnetic circular hub from which said blade extends normally therefrom;
a rotor central permanent magnet approximating a size of said magnetic circular hub;
wherein said rotor and said blade are magnetically coupled and not in physical contact.

16. Simultaneous pumping and mixing by the microfluidic chips of claims 1-6 as fluid elements are continuously folded and stretched by the moving and rotating blade. Pumping is performed immediately as the said blade moves along the microchannel such that the blade's plane remains perpendicular to the centerline of the microchannel. Mixing is performed over long time scales as fluid is circulated in the microfluidic chip and fluid elements are repeatedly folded and stretched by the moving and rotating blade.

17. Controlling simultaneous translations and rotational motions of the said rotor, which have at least one permanent magnet and may have a blade fixed to it, by arrays of microcoils. The arrays of microcoils can either be printed on one layer of the microfluidic chip, or be installed outside the microfluidic chip. Microcoils can be wound around ferromagnetic cores, or be printed as spirals on printable circuits boards (PCBs) or on glass substrates.
